(19) United States
(12) Patent Application Publication
(10) Pub. No.: US 2011/0172916 A1
(43) Pub. Date: Jul. 14, 2011

(54) Mobile Device Positioning In A Constrained Environment

(75) Inventors: Payam Pakzad, Mountain View, CA (US); Alok Aggarwal, Foster City, CA (US); Ayman Fawzy Naguib, Santa Clara, CA (US)

(73) Assignee: QUALCOMM Incorporated, San Diego, CA (US)

(21) Appl. No.: 12/987,879

(22) Filed: Jan. 10, 2011

Related U.S. Application Data
(60) Provisional application No. 61/295,128, filed on Jan. 14, 2010.

(51) Int. Cl. G01C 21/30; G01C 21/10

(52) U.S. Cl. 701/209; 701/220; 701/208

(57) ABSTRACT

The subject matter disclosed herein relates to systems, methods, devices, articles, apparatuses, means, etc. for mobile device positioning in a constrained environment. For certain example implementations, a method may comprise obtaining an estimated velocity distribution and an estimated direction of movement distribution of a mobile device for a current position based at least in part on routability information for a constrained environment. A subsequent position of the mobile device may be estimated based at least in part on the estimated velocity distribution and the estimated direction of movement distribution for the current position. Other example implementations are described herein.

### CLAIM OF PRIORITY UNDER 35 U.S.C. §119

This application claims priority under 35 USC 119 to U.S. Provisional Application Ser. No. 61/295,128, filed 14 Jan. 2010, and entitled “Improved Tracking of a Mobile Station over a Constrained Map,” which is assigned to the assignee hereof and which is incorporated herein by reference.

### BACKGROUND

1. Field

The subject matter disclosed herein relates to, mobile device positioning in a constrained environment.

2. Information

Humankind has always struggled to journey from point “A” to point “B”. In ancient-times, individuals in unfamiliar territory wandered around without guidance or perhaps risked asking local inhabitants for directions. People eventually developed maps to provide written guidance for reaching a desired destination. As literacy and the availability of paper became more common, more people gained the ability to use maps during their travels.

Maps began to be available in electronic form during the 20^{th} century. With the advent of the internet, people could electronically access maps of essentially any place in the world. Web mapping services could also provide directions from point “A” to point “B”. These web-based mapping directions were relatively static. With the invention of satellite-positioning system (SPS) technology and ever-smaller electronic devices, however, so-called turn-by-turn directions could be provided dynamically as people journeyed toward their destination.

Unfortunately, these electronic maps and web-based mapping services focus on providing directions in the outdoors, such as from one postal address to another postal address. Similarly, turn-by-turn directions have been traditionally limited to roadways. An ability to provide analogous mapping and directional services indoors is currently lacking.

### BRIEF DESCRIPTION OF THE FIGURES

Non-limiting and non-exhaustive aspects, features, etc. will be described with reference to the following figures, wherein like reference numerals refer to like parts throughout the various figures.

FIG. 1 is a block diagram illustrating an example of a mobile device moving from a previous position through a current position to a subsequent position according to an implementation.

FIG. 2 is a block diagram illustrating an example of a mobile device associated with a velocity and a direction of movement for a current position (e.g., associated with a velocity distribution and a direction of movement distribution for a position distribution at a current time) to facilitate determining a subsequent position according to an implementation.

FIG. 3 is a block diagram illustrating an example positional analysis to determine a subsequent position of a mobile device based at least partly on a distribution of velocity and/or direction of movement of the mobile device for a current position according to an implementation.

FIG. 4 is a schematic diagram of an example constrained environment for which a routing graph has been created according to an implementation.

FIG. 5 is a block diagram illustrating examples of a shortest Euclidean distance and a shortest map distance between a previous position and a current position according to an implementation.

FIG. 6 is a flow diagram illustrating an example method for mobile device positioning in a constrained environment according to an implementation.

FIG. 7 is a block diagram depicting a shortest map path in accordance with a shortest map distance to illustrate an example approach for estimating a velocity distribution and/or a direction of movement distribution of a mobile device according to an implementation.

FIG. 8 is a flow diagram illustrating an example method for estimating a velocity distribution and/or a direction of movement distribution of a mobile device based at least partly on a determined shortest map path according to an implementation.

FIG. 9 is a flow diagram illustrating an example method for estimating a subsequent position distribution of a mobile device based at least partly on a weighting function according to an implementation.

FIG. 10 is a graphical diagram depicting an example curve that may be used to represent a probabilistic weighting function to obtain a direction of movement distribution, which in turn may be used to estimate a subsequent position of a mobile device according to an implementation.

FIG. 11 is a schematic diagram illustrating an example device, according to an implementation, that may implement one or more aspects of mobile device positioning in a constrained environment.

### SUMMARY

For certain example implementations, a method may comprise obtaining an estimated velocity distribution and an estimated direction of movement distribution of a mobile device for a current position based at least in part on routability information for a constrained environment that includes at least a portion of an interior of a building structure. The method may further comprise estimating a subsequent position of the mobile device based at least in part on the estimated velocity distribution and the estimated direction of movement distribution for the current position. For certain example implementations, a device may comprise at least one memory to store instructions and one or more processors to execute the instructions and cause the device to obtain an estimated velocity distribution and an estimated direction of movement distribution of a mobile device for a current position based at least in part on routability information for a constrained environment that includes at least a portion of an interior of a building structure. The instructions may further cause the device to estimate a subsequent position of the mobile device based at least in part on the estimated velocity distribution and the estimated direction of movement distribution for the current position. For certain example implementations, an article may comprise at least one storage medium having stored thereon instructions executable by one or more processors to: obtain an estimated velocity distribution and an estimated direction of movement distribution for a current position of a mobile device based at least in part on routability information for a constrained environment that includes at least a portion of an interior of a building structure; and estimate a subsequent position of the mobile device based at least in part on the estimated velocity distribution and the estimated direction of movement distribution for the current position. For certain example implementations, an apparatus may comprise: means for obtaining an estimated velocity distribution and an estimated direction of movement distribution for a current position of a mobile device based at least in part on routability information for a constrained environment that includes at least a portion of an interior of a building structure; and means for estimating a subsequent position of the mobile device based at least in part on the estimated velocity distribution and the estimated direction of movement distribution for the current position. It should be appreciated, however, that these are merely example implementations and that other implementations are described herein and may be implemented without deviating from claimed subject matter.

### DETAILED DESCRIPTION

Reference throughout this Specification to “a feature,” “one feature,” “an example,” “one example,” and so forth means that a particular feature, structure, characteristic, etc. described in connection with the feature and/or example is relevant to at least one feature and/or example of claimed subject matter. Thus, the appearances of a phrase such as “in one example,” “an example,” “in one feature,” “a feature,” “in an example implementation,” “for certain example implementations,” and so forth in various places throughout this Specification are not necessarily all referring to the same feature, example, and/or example implementation. Furthermore, the particular features, examples, structures, characteristics, etc. may be combined in one or more example implementations, example systems, and so forth.

As indicated above, electronic maps and web-based mapping services are typically not offered for building structures. Similarly, turn-by-turn directions are not typically provided for indoor environments. Many indoor spaces are sufficiently large and/or difficult to navigate that navigational information may be beneficial, e.g., to a user of a mobile device. In order to provide navigational information or other location-based services (LBS), a location of a mobile device may be acquired.

At least most techniques for determining a position (e.g., of a mobile device) involve some level of error or other inaccuracy. Such inaccuracy can be reduced by combining techniques and/or considering other position-related data. By way of example only, a trajectory of a mobile device may be used to fine tune or otherwise adjust a position estimate. In other words, knowledge of an (estimated) trajectory of a mobile device may be utilized to improve tracking and/or positioning estimates.

Trajectory estimation may utilize routability information of a map and incorporate map constraints by considering a map-distance (as opposed to a direct Euclidean distance) between a previous position of a mobile device and a current position. Specifically, it may be assumed that a user moves at a maximum given velocity V. A possible transition from a point “A” on a map to a point “B” on the map in a time. T may be weighted according to a shortest-path distance on the map, considering, any walls or other obstacles. For example, if a map-distance between points A and B exceeds V*T, then point B may be deemed unlikely, or even impossible, to have been reached in time T.

In an unconstrained environment, existing smoothing methods such as Kalman filtering may be capable of tracking both a velocity and a direction of motion and capable of incorporating this information in a filtering process. This may be achieved, for example, by estimating both a position and a speed vector (e.g., with velocities in x and y directions). In other words, if a user is moving at velocity V to the north at a previous position, then in time T it may be considered more likely that the user has moved to a point at a distance T*V to the north of the previous position as compared to another point with the same distance away but in a southward direction.

For certain example implementations that are described herein, a method may comprise obtaining an estimated velocity distribution and an estimated direction of movement distribution of a mobile device at a current position based at least in part on routability information for a constrained environment. More specifically, an example method may estimate both a velocity distribution and a direction of movement of a mobile device in an environment subject to routability constraints. A subsequent position of the mobile device may be determined based at least in part on the estimated velocity distribution and the estimated direction of movement distribution for the current position. This may improve tracking of a mobile device in a constrained environment, such as an indoor environment with walls and/or other obstacles. Using such enhanced positions and/or improved tracking, navigational information and/or a LBS may be provided to a user (e.g., to a mobile device thereof).

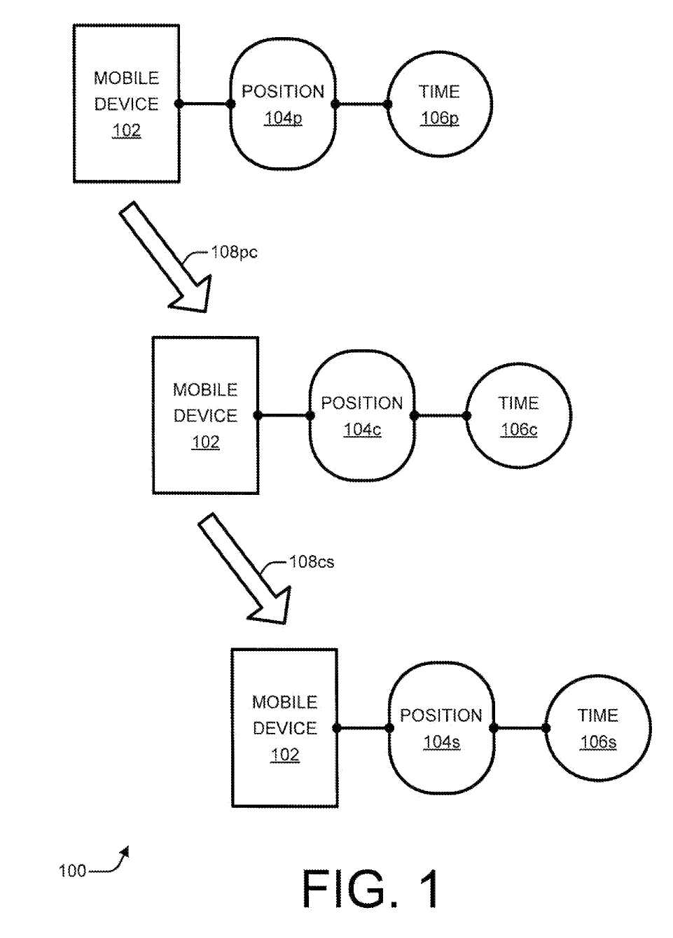

FIG. 1 is a block diagram 100 illustrating an example of a mobile device moving from a previous position through a current position to a subsequent position according to an implementation. As illustrated, block diagram 100 may include a mobile device 102 that is associated with one or more positions 104 and/or with one or more times 106 as mobile device 102 undergoes transitions 108. For certain example implementations, a mobile device 102 may be in motion, such as while being carried by a person or otherwise being transported (including under its own power) from one position to another. A mobile device 102 may be associated with a particular position 104 at any given time 106.

Movement of a mobile device 102 may form a trajectory. A trajectory may be considered a collection of trajectory points (e.g., points in space and time) comprising respective positions 104 of a mobile device 102 at corresponding respective times 106. Transitions 108 represent changes between trajectory points. At previous time 106p, mobile device 102 may be associated with (and located at) previous position 104p. Mobile device 102 undergoes a transition 108pc from a previous trajectory point to a current trajectory point. Time 106 changes during previous-to-current transition 108pc, and position 104 may also change (e.g., while mobile device 102 is in motion).

At current time 106c, mobile device 102 may be associated with (and located at) current position 104c. Mobile device 102 undergoes a transition 108cs from a current trajectory point to a subsequent trajectory point. Time 106 changes during current-to-subsequent transition 108cs, and position 104 may also change. At subsequent time 106s, mobile device 102 may be associated with (and located at) subsequent position 104s. Although not explicitly represented in FIG. 1, mobile device 102 may be in motion before previous time 106p and/or after subsequent time 106s. A mobile device 102 may comprise a mobile station, a mobile phone, a netbook, a laptop, a tablet computer, an entertainment appliance, some combination thereof, and so forth, just to name a few examples, or it may comprise any mobile device with wireless measurement capabilities and/or with other motion-related sensors.

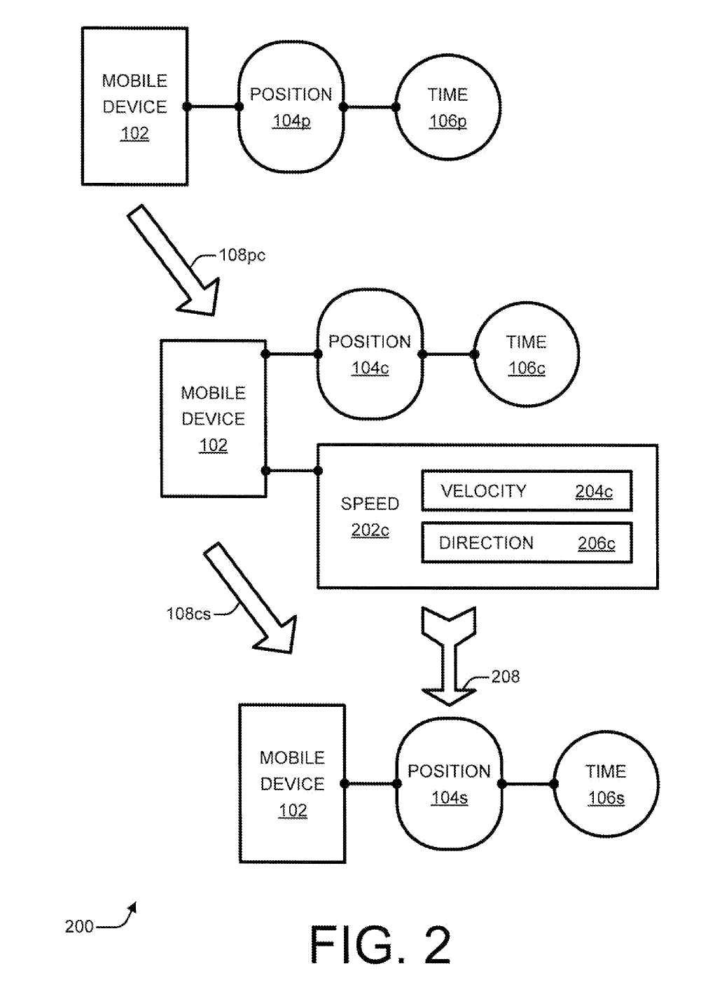

FIG. 2 is a block diagram 200 illustrating an example of a mobile device associated with a velocity and a direction of movement for a current position (e.g., associated with a velocity distribution and a direction of movement distribution for a position distribution at a current time) to facilitate determining a subsequent position according to an implementation. As illustrated, block diagram 200 may include a mobile device 102 at three respective positions 104 at three respective times 106 and a positional analysis 208. More specifically, mobile device 102 may be associated with a previous position 104p at a previous time 106p. Upon a previous-to-current transition 108pc, mobile device 102 may be associated with a current position 104c at a current time 106c. Upon a current-to-subsequent transition 108cs, mobile device 102 may be associated with a subsequent position 104s at a subsequent time 106s.

For certain example implementations, mobile device 102 may be associated with a velocity 204 and/or a direction of movement 206. Mobile device 102 may also be associated with a speed 202. Speed 202 may comprise a vector value that includes velocity 204 and/or direction of movement 206. In such an example implementation, velocity 204 may comprise a magnitude of a vector for speed 202, and direction of movement 206 may comprise a direction of a vector for speed 202. Also, as is known in the art, vectors may be expressed differently (e.g., magnitude and direction, two or three orthogonal components, etc.). Hence, a velocity and a direction of movement may jointly comprise a speed vector that may be considered equivalent to two or more (e.g., orthogonal) velocity components.

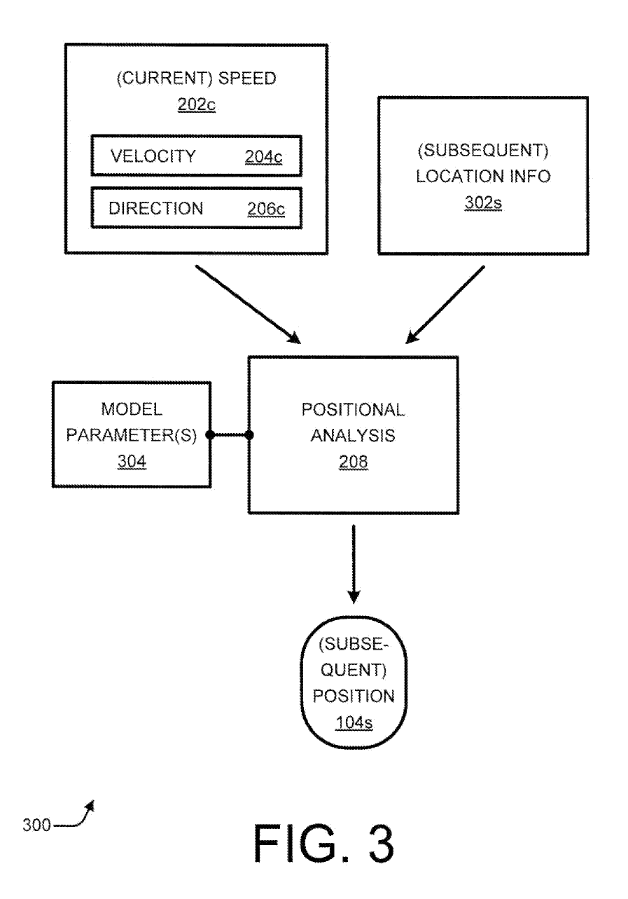

In an example implementation, at least a portion of speed 202 at one time may be used to at least partly determine a position at another time with positional analysis 208. More specifically, at current time 106c, mobile device 102 may be associated with a current velocity 204c and/or a current direction of movement 206c. A current speed 202c may include current velocity 204c and/or current direction of movement 206c. In an example implementation, a subsequent position 104s may be estimated based at least partly on a current velocity 204c. In another example implementation, a subsequent position 104s may be estimated based at least partly on a current direction of movement 206c. In yet another example implementation, a subsequent position 104s may be estimated based at least partly on a current velocity 204c and a current direction of movement 206c. Similarly, a current velocity 204c and/or a current direction of movement 206c may have been estimated based at least partly on an estimated previous position 104p and an estimated previous velocity and an estimated previous direction of movement for previous position 104p. An example positional analysis 208 that may involve using a current velocity 204c and/or a current direction of movement 206c to at least partly determine a subsequent position 104s is described further herein below with particular reference to FIG. 3.

It should be noted that data values representing real-world variables, quantities, amounts, degrees, etc. typically include some level of inaccuracy. In other words, data values that are derived from real-world measurements may be susceptible to some level of error. As such, many data values representing real-world phenomena may be considered to be estimates. Accordingly, positions, times, velocities, directions of movement, trajectories, etc. may be estimated values. They may be measured, estimated, or otherwise determined to a desired level of accuracy and/or a possible level of accuracy given available technology, resources to be applied, and so forth. Although not necessarily referred to explicitly as estimates throughout this Specification, it is to be understood that such data values that are used herein may comprise estimated versions of corresponding real-world variables in certain example implementations. Thus, with each estimate may be an associated level of uncertainty. For example, a ‘real’ current velocity may be any value in a vicinity of an estimated velocity, and similarly for a ‘real’ position and a ‘real’ direction of movement.

Moreover, such values may comprise distributions of values, such as a range of weighted values that may form a probabilistic distribution. For example, a velocity variable may be referred to as a velocity 204 herein for the sake of clarity. However, such a velocity 204 may correspond, for instance, to a velocity distribution (e.g., a probabilistically distributed range of velocity values), a nominal velocity value (e.g., drawn from a probabilistic distribution), any combination thereof, and so forth. Similarly, a direction of movement such as a direction of movement 206 may correspond to a direction of movement distribution, a nominal directional movement value derived there from, any combination thereof, and so forth. Also, a position such as a position 104 may correspond to a position distribution, a nominal positional value derived there from, any combination thereof, and so forth.

An estimation may be made in terms of at least one probability distribution. In an example operative implementation, at any given instance, a processing device may implicitly and/or explicitly maintain a collection of multiple possible or likely scenarios, along with a probability for each such scenario. Separate and/or combined probability distributions/scenarios may be maintained for positions, as well as estimated directions of movement and velocities. A nominal estimated position, direction of movement, and/or velocity may, in example implementations, comprise a mean of a corresponding distribution, a value associated with a highest probability, a number of samples, and so forth, just to name a few examples. An estimation may be performed, for certain example implementations, by implicitly and/or explicitly calculating a probability distribution of a subsequent position/velocity/direction of movement.

Any of many different techniques may be employed to perform such estimating at each epoch. Example estimation techniques include, but are not limited to, Kalman filtering, Bayesian filtering, particle filtering, combinations thereof, and so forth. Kalman filtering may perform estimations by assuming that such distributions are Gaussian. It may therefore be easier to analytically keep track of an evolution of such distributions (e.g., evolution tracking may be accomplished using a mean and a covariance matrix). Bayesian filters may perform such evolutionary estimating by explicitly evolving a full distribution. Particle filtering may perform such estimations by approximately representing distributions by sampling from them (e.g., given that there is an appropriate method to draw independent samples from a given probability distribution). Particle filtering may consider numerous samples from likely scenarios (each with a potentially different candidate position, velocity, and/or direction of movement) to estimate a joint distribution of these quantities after a transition to a new epoch. However, claimed subject matter is not limited to any particular distribution or technique of evolving it.

FIG. 3 is a block diagram 300 illustrating an example positional analysis to determine a subsequent position of a mobile device based at least partly on a distribution of velocity and/or direction of movement of the mobile device for a current position according to an implementation. As illustrated, block diagram 300 includes a current speed 202c, subsequent location information 302s, one or more model parameters 304, a positional analysis 208, and a subsequent position 104s. Current speed 202c may include a current velocity 204c and/or a current direction of movement 206c.

For certain example implementations, a current velocity 204c and/or a current direction of movement 206c may be provided as input data for a positional analysis 208. Subsequent location information 302s may also be provided as input data for a positional analysis 208. Positional analysis 208 may determine subsequent position 104s based at least partly on one or more of current velocity 204c, current direction of movement 206c, and/or subsequent location information 302s. By way of example but not limitation, such location information may be adjusted based at least partly on a trajectory of a mobile device as reflected by a velocity and/or a direction of movement. Although not explicitly shown, such a determination for subsequent position 104s by positional analysis 208 may also be based on alternative and/or additional input data.

In example implementations, location information 302 (such as subsequent location information 302s) may comprise any information that indicates a location of a mobile device. A location of a mobile device may be indicated in a local and/or a global coordinate system. Such location information 302 may be related to data acquired via at least one satellite positioning system (SPS), data acquired via at least one Wi-Fi other “short-range” access point or wireless technology, data acquired via at least one cellular communications system (e.g., by communicating with one or more base stations, femtocells, etc.), data acquired via at least one Worldwide Interoperability for Microwave Access (WiMAX) node, data acquired via at least one Bluetooth connection, any combination thereof, and so forth, just to name a few examples. Location information 302 may also include data such as an image or a sound detected from a mobile device that may indicate a location. However, location information 302 may comprise other information and/or be acquired differently without departing from claimed subject matter.

In example implementations, positional analysis 208 may comprise or otherwise be associated with at least one model parameter 304. Such model parameter(s) 304 may weight different location data of location information 302 differently. For example, model parameter(s) 304 may weight data from an SPS source more strongly than data from a Wi-Fi source, or vice versa. In an example weighting function implementation of a model parameter 304, a higher weight may be given to an SPS signal as compared to a Wi-Fi signal if it is assumed by an underlying model that there is higher fidelity with an SPS signal as opposed to a Wi-Fi signal. A model parameter 304 may also or, alternatively weight a velocity 204 and/or a direction of movement 206 differently. In an example implementation, a model parameter 304 may comprise a probabilistic model parameter that weights values and/or possibilities using a probabilistic distribution. An example probabilistic model parameter approach for analyzing a velocity 204 and/or a direction of movement 206 is described herein further below with particular reference to FIG. 10.

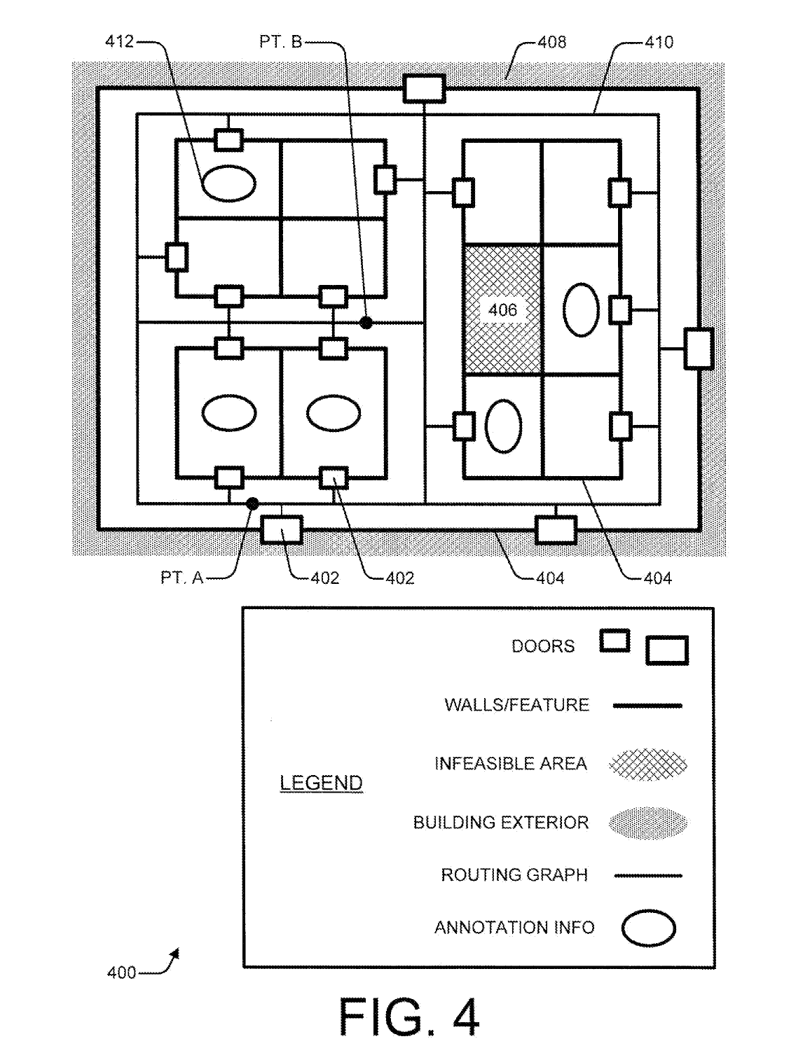

FIG. 4 is a schematic diagram 400 of an example constrained environment for which a routing graph has been created according to an implementation. As illustrated, schematic diagram 400 includes a map of an indoor environment and a routing graph that has been created for the indoor environment. Indoor environments may include office buildings, apartment buildings/complexes, malls, airports, arenas, convention centers, stadiums, and so forth, just to name a few examples. An indoor environment may have walls, doors, columns, stairs, elevators, and so forth. These types of building features and other objects may restrict movement around the indoor environment. Indoor environments may also have open areas such as lobbies, common areas, entryways, rooms, and so forth, just to name few examples. Accordingly, because paths of movement may be restricted in some areas (and unrestricted in other areas) for such an indoor environment, such an indoor environment may be an example of a constrained environment.

For certain example implementations, a routing graph with linked or otherwise associated annotation information may be used to provide navigational information. Navigational information may include, by way of example but not limitation, positioning information, mapping information, directional information, turn-by-turn directions, and so forth. Such navigational information may facilitate travel from a point “A” to a point “B”. By way of example but not limitation, a routing graph with associated annotation information may be descriptive of feasible areas of a given map and indicate how traversal is possible from one position to another position so as to function as an example of routability information. For any given building, a routing graph may comprise a set of nodes and edges that depict feasible areas and traversable paths from one point in a building to another point. A traversable path may comprise, by way of example but not limitation, a path between any two points that is not blocked by a wall or other obstacle. Thus, at least once a routing graph has been created, points of a grid of points may comprise nodes of such a routing graph, and links interconnecting points may comprise edges of such a routing graph. Routing from one location to another may be performed by selecting two points/nodes in a routing graph and running a shortest path algorithm (e.g., Dijkstra, etc.) on the remaining graph.

As shown in example schematic diagram 400, an example routing graph 410 has been created that includes linkages to annotation information 412 from building information that is descriptive of at least a portion of a building structure. Such building information may comprise data that is in any format. Building information may comprise a computer aided design (CAD) file, a drawing interchange format (DXF) file, an image file, some combination thereof, and so forth, just to name a few examples.

As illustrated, schematic diagram 400 may include external/internal doors 402, exterior/interior walls 404, at least one infeasible area 406, a building exterior area 408, a routing graph 410, and annotation information 412. Using routing graph 410, a navigational application and/or system may provide directional instructions for an individual to travel, for instance, from point “A” to point “B”. Although all such illustrated features are not explicitly denoted with reference numerals in FIG. 4 for the sake of visual clarity, a legend indicates which building and navigational features are connoted by which particular drawing features. Also, although schematic diagram 400 generally and routing graph 410 specifically include certain example components as illustrated in FIG. 4 and described herein below, claimed subject matter is not so limited. Instead, given implementations may include more, fewer, and/or different components. For example, building information may omit door indications. Also, infeasible areas may not be identified. Furthermore, additional annotation information and/or additional types of such information may be linked to routing graph 410. Other alternatives and alternative components may be added, incorporated, omitted, changed, and so forth.

By way of example but not limitation, routing graph 410 may be indicative of a routing topology. Routing graph 410 may be retrieved (e.g., from memory, from a remote location, etc.) and/or created so as to correspond to a building structure of schematic diagram 400. To create a routing graph 410, a grid of points may be applied to building information. The building information may be explored using such an applied grid of points. By way of example but not limitation, possible locations on a map may be represented using a discrete set of grid points. This discreteness need not present a problem for an accuracy of an overall system because a granularity of an applied grid points may be increased so as to exceed a desired level of accuracy.

As part of an example exploration of building information, autonomous areas may be determined. Autonomous areas may include rooms, hallways, a building exterior, and so forth, just to name a few examples. At least one autonomous area may be ascertained to comprise a building exterior area 408. One or more other autonomous areas may be determined to comprise an infeasible area 406. For example, an area without a door and/or an area without annotation information may be determined to be infeasible. On the other hand, autonomous areas that are reachable and/or that are associated with annotation information may be determined to comprise feasible areas (e.g., accessible rooms, hallways, etc.).

If doors are indicated in building information, one or more exit and/or entrance doors 402 (e.g., the larger door rectangles in FIG. 4) may be determined if door(s) connect to and provide access to building exterior area 408. One or more internal doors 402 (e.g., the smaller door rectangles in FIG. 4) may be determined to provide access to other feasible areas, such as internal rooms, hallways, and so forth.

Annotation information 412 may be linked to routing graph 410 to further enable navigational or another location-based service between and among different areas (e.g., rooms, zones, etc.). Annotation information 412 may also provide information associated with a particular zone, such a lobby, an elevator bank, a dining location, and so forth, just to name a few examples. By way of example but not limitation, annotation information 412 may include room designations (e.g., “A”, “1.24”, etc.), room names (e.g., “Conference Room 1”, etc.), room purposes, (e.g., “Bathroom”, “Kitchen”, etc.), room residents or occupants (e.g., “Amy”, “Ray”, etc.), zone exhibitors (e.g., “Acme”, “AA Industrializing”, etc.), store owners (e.g., “Rugs-R-Us”, “Nicky's Nick-Knacks”, etc.), and so forth.

Routability information may comprise, for example, information that is capable of aiding and/or facilitating a determination of a route. By way of example but not limitation, routability information may include any one or more of the following: a routing graph 410, annotation information 412 (e.g., that is linked to a routing graph 410), general building information, map information, indication(s) of feasible and infeasible areas, indications of traversable paths, any combination thereof, and so forth, just to name a few examples. A routing graph 410 may be used to plot a path from one point to another point, including from one annotated area to another annotated area. By way of example only, routability information for a constrained environment may include at least a portion of an interior of a building structure.

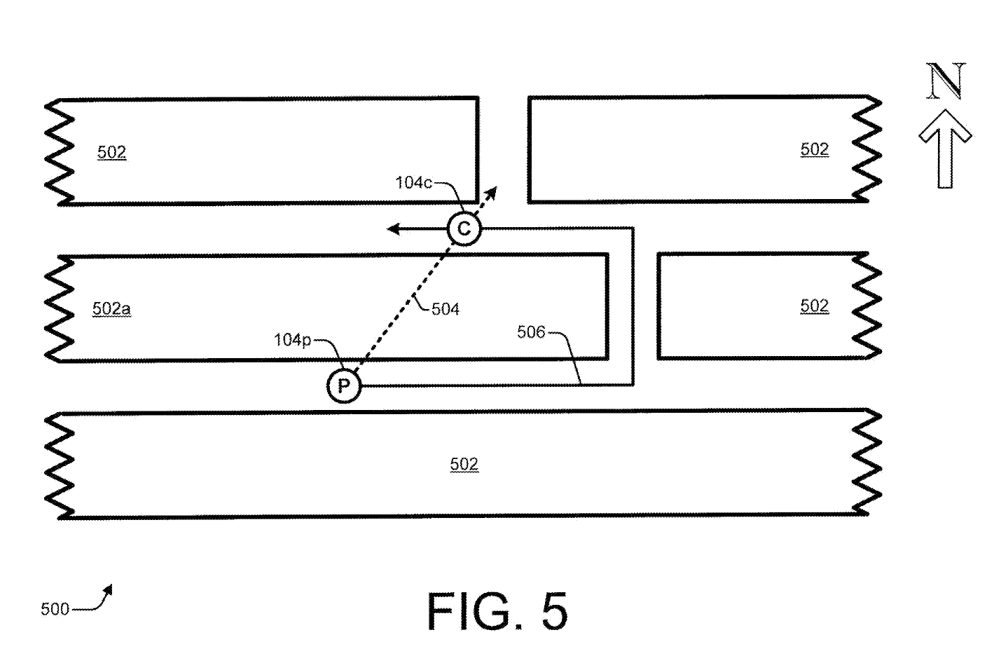

FIG. 5 is a block diagram 500 illustrating an example of a shortest Euclidean distance and an example of a shortest map distance between a previous position and a current position according to an implementation. As illustrated, block diagram 500 may include previous position 104p, current position 104c, multiple barriers 502, a shortest Euclidean path 504 (shown as a dashed arrow), and a shortest map path 506 (shown as a solid arrow). For certain example implementations, barriers 502 may restrict movement of a mobile device (not explicitly shown in FIG. 5) within a constrained environment as represented by block diagram 500. Barriers 502 may be room dividers (e.g., for cubicles), displays, walls, rooms, other obstacles, and so forth, just to name a few examples.

An encircled “P” represents a mobile device at previous position 104p at a previous time. An encircled “C” represents a mobile device at current position 104c at a current time. Hence, a mobile device may move from previous position 104p to current position 104c during a period that elapses from a previous time to a current time. In this sense, block diagram 500 may be considered to graphically represent a previous-to-current transition 108pc (e.g., of FIGS. 1 and 2).

Generally, a shortest Euclidean distance (e.g., in two-dimensional space) between two points may be considered a direct path as represented by a single straight line between the two points. In block diagram 500, a shortest Euclidean path 504 is shown as a straight arrow between previous position 104p and current position 104c. If it were assumed that a mobile device traveled from previous position 104p to current position 104c along shortest Euclidean path 504, then at a current time associated with current position 104c, a direction of movement for the mobile device might be assumed to be (approximately) north-east. However, barrier 502a prevents a mobile device from traveling along shortest Euclidean path 504. Hence, neither a distance nor a direction associated with shortest Euclidean path 504 is likely to be relevant to a mobile device that moves from previous position 104p to current position 104c.

Instead, for certain example implementations, a mobile device may be assumed to travel over a map path. A map path is a path that is traversable by a mobile device in accordance with a connectivity or routing graph corresponding to a constrained environment in which the mobile device is present and moving. For example, it may be assumed that a mobile device does not pass through barriers 502. In an example as illustrated for block diagram 500, a mobile device may travel from previous position 104p to current position 104c over map path 506. In this case, the traveled map path may be considered a shortest map path 506.

As shown, shortest map path 506 may include three segments: an eastward segment, a northward segment after a “left” turn, and a westward segment after another “left” turn. At current position 104c and an associated current time, a mobile device having traveled over shortest map path 506 may be assumed to have a westward direction of movement. Moreover, a distance traveled by a mobile device over shortest map path 506 may be a sum of an eastward segment, a northward segment, and a westward segment. Such a map distance for shortest map path 506, at least in this instance, is greater than a Euclidean distance of shortest Euclidean path 504. Hence, a direction of movement, a distance traveled, or both may vary for a mobile device that travels either a shortest Euclidean path 504 or a shortest map path 506. If a time of travel (e.g., current time−previous time) is the same for both paths, a velocity associated with a traveling mobile device may differ when a traveled distance differs. This is apparent from a consideration of the following equation: velocity=distance/time.

Thus, a direction of movement and a velocity may be determined for a mobile device that is assumed to travel over a shortest Euclidean path 504 between a previous position 104p and a current position 104c. Also, a direction of movement and a velocity may be determined for a mobile device that is assumed to travel over a shortest map path 506. These directions of movement and velocities that are determined for different paths are likely to be different. Because a shortest map path 506 may reflect barriers 502 and other movement restrictions existing in a constrained environment in which a mobile device is present, a direction of movement and a velocity that is determined based at least partly on a shortest map path 506 is more likely to accurately reflect a true direction of movement (e.g., a more accurate direction of movement distribution) and an actual velocity (e.g., a more accurate velocity distribution) of a mobile device.

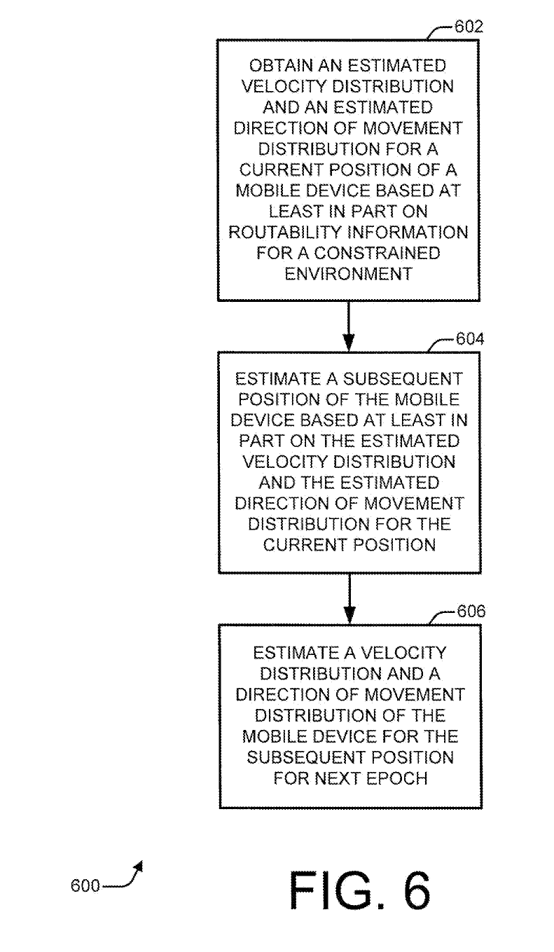

FIG. 6 is a flow diagram 600 illustrating an example method for mobile device positioning in a constrained environment according to an implementation. As illustrated, flow diagram 600 may include three operational blocks 602, 604, and 606. Although operations 602-606 are shown and described in a particular order, it should be understood that methods may be performed in alternative manners (including with a different number of operations) without departing from claimed subject matter. Also, operations of flow diagram 600 may be performed so as to be fully or partially overlapping one another. Additionally, although the description below references particular aspects and features illustrated in certain other figures (e.g., FIGS. 1-5), methods may be performed with other aspects and/or features.

For certain example implementations, at operation 602, an estimated velocity distribution and an estimated direction of movement distribution may be obtained for a current position of a mobile device based at least in part on routability information for a constrained environment. For example, a current velocity 204c and a current direction of movement 206c may be obtained for a current position 104c of a mobile device 102 based at least in part on routability information (e.g., a routing graph 410 and/or annotation information 412) for a constrained environment (e.g., an indoor or other environment having barriers 502 or other movement restrictions). For instance, current velocity 204c and/or current direction of movement 206c of current position 104c may be determined based at least partly on a shortest map path 506 between a previous position 104p and current position 104c.

At operation 604, a subsequent position of the mobile device may be estimated based at least in part on the estimated velocity distribution and the estimated direction of movement distribution for the current position. For example, a subsequent position 104s of mobile device 102 may be determined with a positional analysis 208 based at least in part on current velocity 204c and current direction of movement 206c of current position 104c. For instance, current velocity 204c and current direction of movement 206c that are associated with current position 104c may be used with subsequent location information 302s (e.g., in conjunction with model parameter(s) 304 as part of a positional analysis 208) to determine subsequent position 104s. In another example implementation, a probability distribution of the subsequent position of the mobile device may be determined (e.g., recursively) based at least partly on a joint probability distribution of the current position of the mobile device, an estimated direction of movement for the current position, and an estimated velocity for the current position. As indicated above generally, operations 602-606 may be performed in different orders and/or fully or partially overlapping. Moreover, at least part of operations 604 and 606, for example, may be performed jointly.

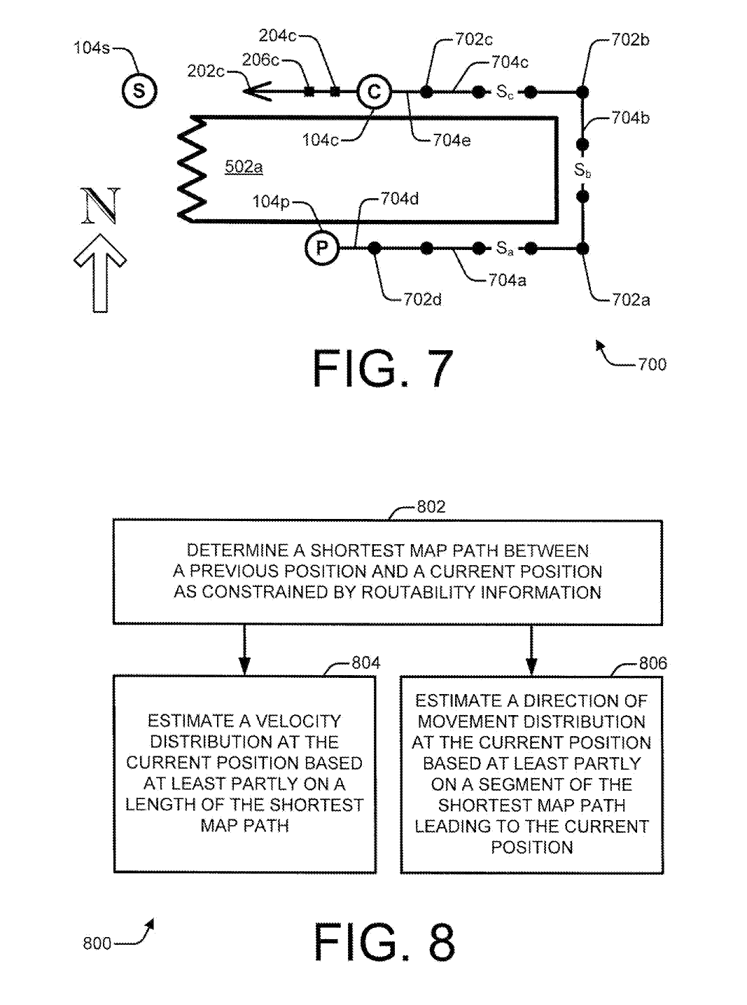

At operation 606, for a next epoch, a velocity distribution and a direction of movement distribution of the mobile device may be estimated for the subsequent position. Example approaches to estimating velocity distributions and direction of movement distributions at each epoch are described herein below with particular reference to FIGS. 7 and 8. With these estimated values, another position of the mobile device may be estimated for the next epoch to continue positioning the mobile device. Thus, trajectory estimation may be implemented by estimating a current position of a mobile device at each epoch using past and current measurements (and hence, also past estimates) so as to smooth an overall trajectory of the mobile device in a realistic fashion. For example, a trajectory of a mobile device 102 may be tracked by recording (e.g., storing, transmitting, etc.) a current position 104c in association with a current time 106c at each epoch. Moreover, a current velocity 204c and/or a current direction of movement 206c may be recorded in association with a current position 104c and/or a current time 106c. Current velocity 204c and/or current direction of movement 206c may be used to estimate and/or improve an accuracy of a subsequent position 104s of mobile device 102. Generally, a trajectory may be tracked as a mobile device 102 undergoes transitions 108 from one position 104 and/or time 106 to another position 104 and/or time 106.

Navigational information (e.g., turn-by-turn directional instruction(s), directions from one location to another location, etc.) may be provided based at least partly on one or more of a current position 104c, a subsequent position 104s, a designated destination, and so forth. They may be provided by presenting them to a user (e.g., visually and/or aurally), by transmitting them to a mobile device, some combination thereof, and so forth, just to provide a few examples.

FIG. 7 is a block diagram 700 depicting a shortest map path in accordance with a shortest map distance to illustrate an example approach for estimating a velocity distribution and/or a direction of movement distribution of a mobile device according to an implementation. As illustrated, block diagram 700 may include a previous position 104p, a current position 104c, a subsequent position 104s, a current speed 202c, and at least one barrier 502a. As noted herein above, current speed 202c may comprise or correspond to a current velocity 204c and/or a current direction of movement 206c for a current position 104c. Block diagram 700 may further include multiple points 702 and one or more segments 704.

As shown, an encircled “P” represents a mobile device (not explicitly shown in FIG. 7) at previous position 104p at a previous time. An encircled “C” represents a mobile device at current position 104c at a current time. An encircled “S” represents a mobile device at subsequent position 104s at a subsequent time. Hence, a mobile device may move from previous position 104p to current position 104c during a period that elapses from a previous time to a current time. In this sense, block diagram 700 may be considered to graphically represent a previous-to-current transition 108pc (e.g., of FIGS. 1 and 2).

For certain example implementations, one or more segment(s) 704 may comprise or correspond to shortest map path 506 (of FIG. 5). More specifically, a shortest map path for movement from previous position 104p to current position 104c may be comprised of three overall segments Sₐ, S_{b}, and S_{c}, which are also designated as segment 704a, segment 704b, and segment 704c, respectively. Overall segments may extend between a previous position 104p and a current position 104c, between a previous position 104p and an inflection point (e.g., point 702a and/or point 702b), between a current position 104c and an inflection point, between two inflection points, and so forth, just to name a few examples. Multiple points 702 (e.g., a point 702a, a point 702b, a point 702c, and a point 702d) are explicitly indicated with reference numbers in block diagram 700. However, some such reference numbers are omitted for the sake of visual clarity. Points 702 may correspond to points in a grid of points used to explore building information and/or create a connectivity/routing graph (e.g., as noted herein above with particular reference to FIG. 4). Also or alternatively, points 702 may correspond to nodes in a routing graph. In such a circumstance, lines that are illustrated between any two points 702 may correspond to edges in such a routing graph.

As illustrated in block diagram 700, four points 702 are individually identified: point 702a, point 702b, point 702c, and point 702d. Points 702a and 702b may comprise points where a direction of movement changes (e.g., points of directional inflection) along a path between previous position 104p and current position 104c. (In a real-world situation, actual mobile device movement may be less straight and without exact right angles for turns, even within hallways of a building structure.) Point 702d is illustrated as a first point of travel after previous position 104p. Point 702c is illustrated as a last point of travel prior to current position 104c.

To estimate a current velocity 204c at a current position 104c, a distance traversed over segments 704a, 704b, and 704c may be determined along with a time that elapses to traverse the distance. For example, an estimated total distance between previous position 104p and current position 104c may be calculated by summing lengths of segments 704 that form a path between the two positions. For instance, a total distance may equal a length of segment 704a plus a length of segment 704b plus a length of segment 704c. A total time may equal a current time associated with current position 104c minus a previous time associated with previous position 104p. Hence, a current velocity 204c at current position 104c may equal a total distance divided by a total time. However, a current velocity 204c at a current position 104c may be estimated in alternative manners without departing from claimed subject matter.

To estimate a current direction of movement 206c at a current position 104c, a direction of movement traversed by a mobile device prior to reaching and/or as it reaches current position 104c may be considered. For example, a current direction of movement 206c at current position 104c may be estimated based at least partly on a segment of a shortest map path leading to current position 104c, which indicates a westward direction of movement as shown in FIG. 7. As illustrated, such a segment may correspond to a segment between (i) a point 702b at which a direction most recently changed and (ii) current position 104c. Alternatively, such a segment may correspond to a segment 704e between (i) a point 702c (e.g., a most-recently passed point or a most proximate (and traversed) point) and (ii) current position 104c. A directional distribution for segment 704e may be used as a direction of movement distribution at current position 104c. Thus, a direction traversed for such a segment may be used, for instance, as a current nominal direction of movement 206c. A probabilistic model for changes in direction of movement and/or velocity may then be applied to a current nominal direction and/or velocity to obtain corresponding distribution(s). However, a current direction of movement 206c at a current position 104c may be estimated in alternative manners without departing from claimed subject matter.

Example approaches for estimating a current velocity 204c and/or a current direction of movement 206c at a current position 104c are described above. These values may be estimated based on at least an approximate path a mobile device traverses between a previous position 104p and a current position 104c. Such a path between a previous position 104p and a current position 104e may be determined based at least partly on a shortest map path between previous position 104p and current position 104c. A shortest map path may be determined using, for example, a routing graph and one or more shortest path algorithms.

A shortest path algorithm may be run, for example, on a connectivity graph of a map in which edges denote possible transitions on the map and in which each edge is weighted by its length. Examples of shortest path algorithms include, but are not limited to, Dijkstra, Bellman-Ford. A*Search, Floyd-Warshall, Johnson's, Perturbation (especially for a locally shortest-path), derivatives thereof, combinations thereof, and so forth. However, claimed subject matter is not limited to any particular shortest path algorithm. Moreover, time, processing, or other constraints may lead one to utilize a sub-optimum shortest path (e.g., if a connectivity graph is particularly complex). By applying a shortest path algorithm, a shortest map path between a previous position 104p and a current position 104c may be determined.

Shortest path algorithms may retain a distance traveled for a given path under analysis. A new shortest path algorithm and/or a modification of an existing shortest path algorithm may be made such that at least a direction of movement upon reaching a mobile device position (or a point that is proximate thereto) is also retained. A shortest path algorithm may retain a beginning direction as well as an ending direction for each determined shortest path. These directions for a beginning segment (e.g., a segment 704d that starts a shortest path) and an ending segment (e.g., a segment 704e that terminates a shortest path) of a shortest path may be used as estimated beginning and ending directions of motion in movement between beginning and ending points. In short, in addition to keeping a current estimate of a shortest-distance, a shortest-path algorithm may also keep track of beginning and/or ending directions for the shortest path.

FIG. 8 is a flow diagram 800 illustrating an example method for estimating a velocity distribution and/or a direction of movement distribution of a mobile device based at least partly on a determined shortest map path according to an implementation. As illustrated, flow diagram 800 may include three operational blocks 802, 804, and 806. Although operations 802-806 are shown and described in a particular order, it should be understood that methods may be performed in alternative manners (including with a different number of operations) without departing from claimed subject matter. Also, operations of flow diagram 800 may be performed so as to be fully or partially overlapping one another. Additionally, although the description below references particular aspects and features illustrated in certain other figures (e.g., FIGS. 1, 2, 4, 5, and 7), methods may be performed with other aspects and/or features.

For certain example implementations, one or more operations of flow diagram 800 may be performed as part of operation 602 (of FIG. 6). At operation 802, a shortest map path may be determined between a previous position and a current position as constrained by routability information. For example, a shortest map path 506 between a previous position 104p and a current position 104c may be determined based at least partly on routability information (e.g., a routing graph 410 and/or annotation information 412) for a constrained environment.

At operation 804, a velocity distribution at the current position may be estimated based at least partly on a length of the shortest map path. For example, a current velocity 204c at current position 104c may be estimated based at least partly on a length of a shortest map path (e.g., a sum of distances for segments 704 comprising a shortest map path 506) and a time that elapses to travel between previous position 104p and current position 104c.

At operation 806, a direction of movement distribution at the current position may be estimated based at least partly on a segment of the shortest map path leading to the current position. For example, a current direction of movement 206c at current position 104c may be estimated based at least partly on a direction corresponding to a segment (e.g., a segment 704e starting at a point 702c (that is a most-proximate point) or a segment 704c starting at a point 702b (that is a most-recent inflection point)) of a shortest map path that leads to current position 104c.

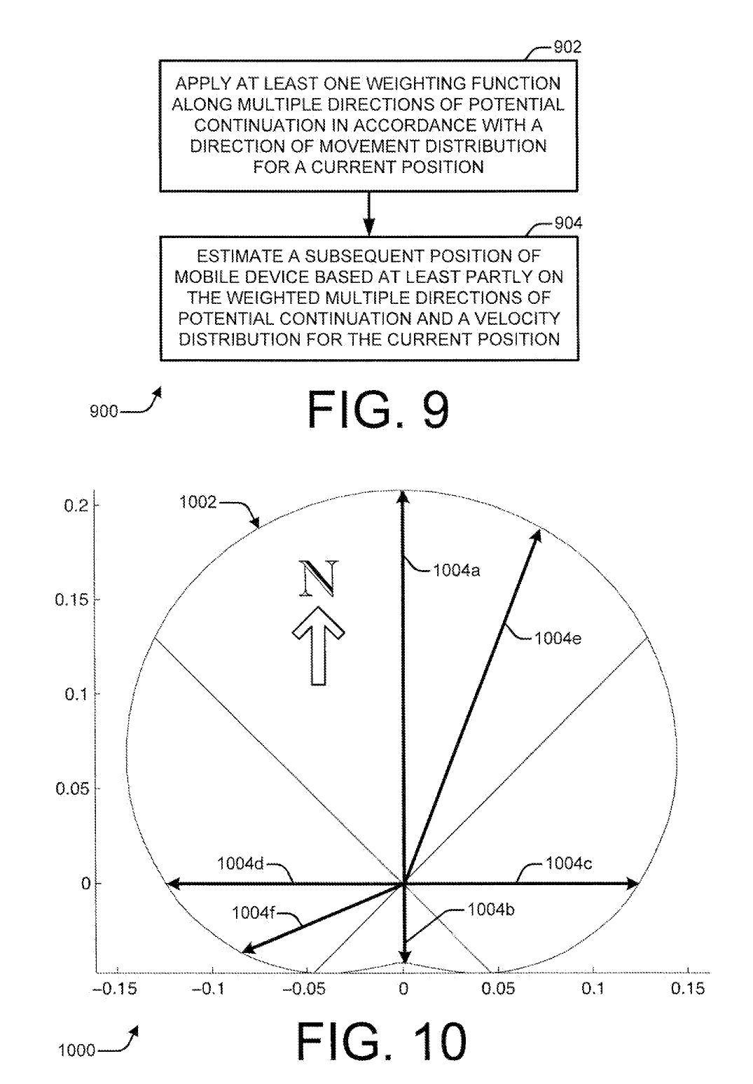

An example trajectory estimation method may use both map-distances and directions of movement in determining transition likelihoods (e.g., probabilities). In particular, it may be assumed that a mobile device is more likely to continue in a same direction of motion as opposed to changing to another direction. In other words, after having moved from a first point to a second point, a mobile device is more likely to continue towards those points on a map whose shortest-path from the second point starts/begins with the same direction in which a shortest path from the first to the second point terminates. Such a notion may be accommodated using, for example, an example method in accordance with flow diagram 900 (of FIG. 9) and/or an example curve that can reflect an appropriate probability distribution in accordance with graphical diagram 1000 (of FIG. 10).

FIG. 9 is a flow diagram 900 illustrating an example method for estimating a subsequent position distribution, of a mobile device based at least partly on a weighting function according to an implementation. As illustrated, flow diagram 900 may include two operational blocks 902 and 904. Although operations 902 and 904 are shown and described in a particular order, it should be understood that methods may be performed in alternative manners (including with a different number of operations) without departing from claimed subject matter. Also, operations of flow diagram 900 may be performed so as to be fully or partially overlapping one another. Additionally, although the description below references particular aspects and features illustrated in certain other figures (e.g., FIGS. 1-3), methods may be performed with other aspects and/or features.

For certain example implementations, one or more operations of flow diagram 900 may be performed as part of operation 604 (of FIG. 6). At operation 902, at least one weighting function may be applied along multiple directions of potential continuation of movement in accordance with a direction of movement distribution for a current position. For example, as part of a positional analysis 208, directions of potential continued movement may be weighted as one or more model parameter(s) 304 in accordance with their respective proximities to an estimated current direction of movement 206c at a current position 104c. For instance, a potential direction of continued movement that is equivalent to a current direction of movement at a current position may be weighed more heavily than a potential direction of continued movement that is opposite (e.g., 180 degrees different from) the current direction of movement at the current position.

At operation 904, a subsequent position distribution of a mobile device may be estimated based at least partly on the weighted multiple directions of potential continuation of movement and a velocity distribution for the current position. For example, a subsequent position 104s of a mobile device 102 at a subsequent time 106s may be estimated based at least partly on how directions of potential continued movement are weighted by one or more model parameter(s) 304, such as at least one weighting function, as part of positional analysis 208. By way of example but not limitation, such weighting of potential directions of continued movement may be effectuated using, at least partly, a probabilistic mechanism. An example probabilistic mechanism is described herein further below with particular reference to FIG. 10.

Thus, a probability distribution for a subsequent position may be estimated from a probability distribution relating to a direction, a velocity, and a current position. Alternatively, example implementations may be formulated in terms of independent samples from such distributions. For example, operation 902 may alternatively be described in terms of drawing a possible continuation direction based at least partly on a current estimated position and a weighting function. A nominal velocity value may also be drawn from a current estimated velocity and a nominal direction. Similarly, operation 904 may alternatively be described in terms of estimating a subsequent position of a mobile device in accordance with a sampled direction and velocity, as well as the current position. In other words, a subsequent position sample may be derived from a probability distribution using a sampled value of velocity and a sampled value of direction from respective probability distributions and/or at least one joint probability distribution. A nominal velocity may also be drawn from a probability function so as to model changes in velocity. An example probability model for velocity may be a Gaussian distribution having a mean value that is the nominal calculated velocity and with a variance that may be selected appropriately.

FIG. 10 is a graphical diagram 1000 depicting an example curve that may be used to represent a probabilistic weighting function to obtain a direction of movement distribution, which in turn may be used to estimate a subsequent position of a mobile device according to an implementation. As illustrated, graphical diagram 1000 includes an abscissa axis (the x-axis), an ordinate axis (the y-axis), a curve 1002 denoting a probability distribution, as is described subsequently, and multiple rays 1004. In the example shown in FIG. 10, the abscissa axis extends from −0.15 to +0.15, and the ordinate axis extends from −0.05 to +0.2. For certain example implementations, curve 1002 may be roughly circular or oval. However, its shape may be modified to account for a constrained environment (e.g., compressed to extend along a hallway and swollen to curve around a corner).

Subsequent positions that may be reached by a mobile device if it were to continue traveling in a same or similar direction as at a current position may be assigned relatively higher probabilities. Conversely, subsequent positions that may be reached by a mobile device if it were to deviate “significantly” from continuing to travel in a same or similar direction as at a current position may be assigned relatively lower probabilities.

An underlying assumption in certain implementations as described herein is that a user traveling in a given direction at a current position is likely to continue to travel in that given direction in a succeeding time instant, perhaps even until a subsequent estimating position is reached. However, in reality a user may well change direction between measuring times/positions. Furthermore, an estimation of a direction of movement distribution may not be made precisely. Consequently, a possibility of movement in other directions by a mobile device may be accounted for while continuing along an estimated track using, e.g., a probabilistic weighting function.

In an example implementation, weights may be distributed to different directions of potential movement continuation according to how close they are to a current estimated direction of movement distribution, or nominal sample thereof. An example of such a distribution may be produced using the following formula:

cos(Θ)/12+⅛,

where Θ is an angle between an estimated current direction of movement and a candidate potential direction. Such a distribution may be normalized so that a total over eight cardinal: directions (e.g., N, NE, E, SE, S, SW, W, NW) sums up to one (1). However, claimed subject matter is not limited to any particular type of weighting function.

Curve 1002 depicts an example of such an approach to weighting directions. Angles may be relative to an original northerly direction, and a length of a ray 1004 from an origin of (0,0) to curve 1002 denotes a weight associated with each direction corresponding to a respective ray 1004. As shown for this example, continuing in a northern direction as in a ray 1004a is five times as likely as reversing direction towards the south as in a ray 1004b, and it is 5/3rd as likely as going in a perpendicular direction of east or west as in a ray 1004c or a ray 1004d, respectively. A full reversal of a direction of movement is considered a least likely directional change, so a length of ray 1004b is shortest. As another example, a length of a ray 1004e (which roughly corresponds to a north-east-north direction) is longer than a length of a ray 1004f (which roughly corresponds to a west-south-west direction). Consequently, a probability that a mobile device will veer towards a north-east-north direction is greater than a probability that it will veer towards a west-south-west direction in accordance with a probabilistic weighting function corresponding to curve 1002.

A form of a weighting function may be tuned using information such as a user-specific profile of movement, floor-plan pattern (e.g., an office building with many intersections, a mostly open mall area, etc.), frequency and accuracy of measurements, other relevant factors, combinations thereof, and so forth, just to name a few examples. Moreover, weighting functions specifically and model parameters generally may be implemented in manners that differ from those described with reference to FIG. 10 without departing from claimed subject matter.

Certain example methods as described herein for estimating a velocity distribution and/or a direction of movement distribution of a targeted mobile device may be combined and incorporated with a variety of techniques that use transition probabilities for constrained movement between points on a map to improve tracking of the mobile device. Examples of such tracking methods that may be improved by incorporating example implementation(s) that are described herein include, but are not, limited to, full or reduced Bayesian filter, hidden Markov model on a simplified connectivity graph, particle filter, various versions of a forced Kalman filter, and so forth, just to name a few examples.

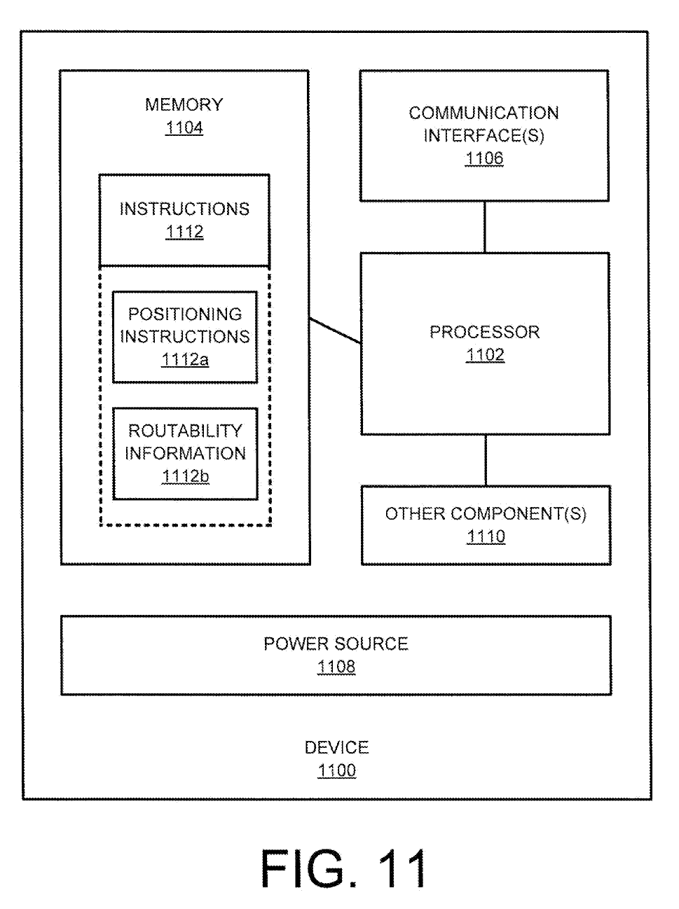

FIG. 11 is a schematic diagram illustrating an example device 1100, according to an implementation, that may implement one or more aspects of mobile device positioning in a constrained environment. As illustrated, device 1100 may include at least one processor 1102, one or more memories 1104, at least one communication interface 1106, at least one power source 1108, and other component(s) 1110, such as an SPS unit (SPSU) (not explicitly shown). Memory 1104 is illustrated as including instructions 1112. However, a device 1100 may alternatively include more, fewer, and/or different components from those that are illustrated.

For certain example implementations, device 1100 may include and/or comprise an electronic device. Device 1100 may comprise, for example, any electronic device having at least one processor and/or memory. Examples for device 1100 include, but are not limited to, relatively fixed processing devices (e.g., a desktop computer, one or more server computers, at least one telecommunications node, an intelligent router/switch, an access point, some combination thereof, etc.), relatively mobile processing devices (e.g., a notebook computer, a personal digital assistant (PDA), a netbook, a slate or tablet computer, a portable entertainment device, a mobile phone, a smart phone, a mobile station, some combination thereof, etc.), and so forth.

Power source 1108 may provide power to components and/or circuitry of device 1100. Power source 1108 may be a portable power source, such as a battery, or a fixed power source, such as an outlet in a car, house, or other building. Power source 1108 may also be a transportable power source, such as a solar or carbon-fuel-based generator. Power source 1108 may be integrated with or separate from device 1100.

Processor 1102 may comprise any one or more processing units. Memory 1104 may store, contain, or otherwise provide access to instructions 1112 (e.g., a program, an application, etc. or portion thereof; operational data structures; processor-executable instructions; code; some combination thereof; and so forth) that may be executable by processor 1102. Execution of such instructions 1112 by one or more processors 1102 may transform device 1100 into a special-purpose computing device, apparatus, platform, some combination thereof, and so forth.

Instructions 1112 may include positioning instructions 1112a, routability information 1112b, and so forth, just to name a few examples. Routability information 1112b may comprise, by way of example but not limitation, any one or more of the following: building information, map information, at least one connectivity and/or routing graph, annotation information, traversable paths, feasible/infeasible areas, combinations/derivatives thereof, and so forth. Positioning instructions 1112a may correspond to, for example, instructions that are capable of realizing at least a portion of one or more implementations of flow diagrams 600, 800, and/or 900 (of FIGS. 6, 8, and 9). Positioning instructions 1112a may be executed to, for example, estimate a position of a mobile device based at least partly on routability information 1112b for a constrained environment. Although not explicitly shown, instructions 1112 may also include instructions to further track a trajectory of a mobile device, to provide one or more location-based services (LBS), and so forth, just to name a few examples.

In an example implementation, a relatively fixed processing device, such as a server and/or telecommunications node, may execute positioning instructions 1112a to estimate a mobile device position based at least partly on routability information 1112b. A same or a different relatively fixed processing device may use such an estimated position to provide a LBS to, e.g., a mobile device, which may include an SPSU. Alternatively, such a relatively fixed processing device may provide routability information 1112b and/or an estimated position to a mobile device to enable or otherwise further performance of some LBS. As still another alternative, a mobile device may include positioning instructions 1112a to estimate its own position based at least partly on routability information 1112b. Other alternatives may instead be implemented without departing from claimed subject matter.

Communication interface(s) 1106 may provide one or more interfaces between device 1100 and other devices (e.g., and/or human operators). Hence, communication interface 1106 may include a screen, speaker, keyboard or keys, or other human-device input/output feature(s). Communication interface 1106 may include a transceiver (e.g., transmitter and/or receiver), a radio, an antenna, a wired interface connector or other such apparatus, some combination thereof, etc. to communicate wireless and/or wired signals (e.g., over wireless or wired communication links). Communication interface 1106 may also serve as a bus or other interconnect between and/or among other components of device 1100. Other component(s) 1110, if present, may comprise one or more other miscellaneous sensors, features, and so forth.

Methodologies described herein may be implemented by various means depending upon applications according to particular features and/or examples. For example, such methodologies may be implemented in hardware, firmware, software, discrete/fixed logic circuitry, any combination thereof, and so forth. In a hardware and/or logic circuitry implementation, for example, a processor/processing unit may be implemented within one or more application specific integrated circuits (ASICs), digital signal processors (DSPs), digital signal processing devices (DSPDs), programmable logic devices (PLDs), field programmable gate arrays (FPGAs), processors generally, controllers, micro-controllers, microprocessors, electronic devices, other devices or units programmed to execute instructions and/or designed to perform the functions described herein, and/or combinations thereof, just to name a few examples. Herein, the term “control logic” may encompass logic implemented by software, hardware, firmware, discrete/fixed logic circuitry, any combination thereof, and so forth.

For a firmware and/or software implementation, the methodologies may be implemented with modules (e.g., procedures, functions, etc.) having instructions that perform the functions described herein. Any machine readable medium tangibly embodying instructions may be used in implementing the methodologies described herein. For example, software coding may be stored in a memory and executed by a processor. Memory may be implemented within the processor or external to the processor. As used herein the term “memory” refers to any type of long term, short term, volatile, nonvolatile, or other storage memory/medium and is not to be limited to any particular type of memory or number of memories, or type of media upon which memory is stored.

In one or more example implementations, the functions described may be implemented in hardware, software, firmware, discrete/fixed logic circuitry, some combination thereof, and so forth. If implemented in firmware and/or software, the functions may be stored on a physical computer-readable (e.g., via electrical digital signals) medium as one or more instructions or code (e.g., and realized as at least one article of manufacture comprising at least one storage medium having instructions stored thereon). Computer-readable media include physical computer storage media that may be encoded with a data structure, computer program, a combination thereof, and so forth. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer and/or processor thereof. Disk and disc, as used herein, includes compact disc (CD), laser disc, optical disc, digital versatile disc (DVD), floppy disk and blu-ray disc, where disks usually reproduce data magnetically, while discs usually reproduce data optically with lasers.

Also, computer instructions/code/data may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions and/or data may be transmitted in portions (e.g., first and second portions) at different times (e.g., at first and second times).

Electronic devices may also operate in conjunction with Wi-Fi/WLAN or other wireless networks. For example, positioning data may be acquired via a Wi-Fi or other wireless network. In addition to Wi-Fi/WLAN signals, a wireless/mobile device may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System). Furthermore, implementations described herein may be used with positioning determination systems that utilize pseudolites or a combination of satellites and pseudolites. Pseudolites are usually ground-based transmitters that broadcast a Pseudo-Random Noise (PRN) code or other ranging code (e.g., similar to a GPS or CDMA cellular signal) that is modulated on an L-band (or other frequency) carrier signal, which may be synchronized with GPS time. Each such transmitter may be assigned a unique PN code so as to permit identification by a remote receiver. Pseudolites may be particularly useful in situations where SPS signals from an orbiting satellite might be unavailable, such as in tunnels, mines, buildings, urban canyons, or other enclosed areas. Another implementation of pseudolites is known as radio-beacons. The term “satellite”, as used herein, is also to include pseudolites, equivalents of pseudolites, and similar and/or analogous technologies. The term “SPS signals”, as used herein, is also to include SPS-like signals from pseudolites or equivalents of pseudolites. Certain implementations may also be applied to femtocells or a combination of systems that includes femtocells. For example, femtocells may provide data and/or voice communication. Moreover, femtocells may provide positioning data.

In an example implementation, an SPSU (when present) may be capable of determining a location of device 1100 using an SPS system or systems. Hence, example implementations that are described herein may be used with various SPSs. An SPS typically includes a system of transmitters positioned to enable entities to determine their location on or above the Earth based, at least in part, on signals received from the transmitters. Such a transmitter typically, but not necessarily, transmits a signal marked with a repeating pseudo-random noise (PN) code of a set number of chips and may be located on ground based control stations, user equipment, and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals may include SPS, SPS-like, and/or other signals associated with such one or more SPS.

Some portions of this Detailed Description are presented in terms of algorithms or symbolic representations of operations on binary digital signals that may be stored within a memory of a specific apparatus or special purpose computing device or platform. In the context of this particular Specification, the term specific apparatus or the like includes a general purpose computer once it is programmed to perform particular functions pursuant to instructions from program software/instructions. Algorithmic descriptions or symbolic representations are examples of techniques used by those of ordinary skill in the signal processing or related arts to convey the substance of their work to others skilled in the art. An algorithm here, and generally, may be considered to be a self-consistent sequence of operations or similar signal processing leading to a desired result. In this context, operations or processing involve physical manipulation of physical quantities. Typically, although not necessarily, such quantities may take the form of electrical and/or magnetic signals capable of being stored, transferred, combined, compared, transmitted, received, or otherwise manipulated.

It has proven convenient at times, principally for reasons of common usage, to refer to such signals as bits, data, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “analyzing,”, “identifying,” “associating,” “obtaining,” “performing,” “applying,” “tracking,” “measuring,” “estimating,” “creating,” “detecting,” “providing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, and/or magnetic quantities within memories, registers, or other information storage devices, transmission devices, or display devices of the special purpose computer or similar special purpose electronic computing device.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concepts described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
obtaining an estimated velocity distribution and an estimated direction of movement distribution for a current position of a mobile device based at least in part on routability information for a constrained environment that includes at least a portion of an interior of a building structure; and
estimating a subsequent position of the mobile device based at least in part on the estimated velocity distribution and the estimated direction of movement distribution for the current position.

2. The method of claim 1, wherein said obtaining further comprises:
obtaining the estimated velocity distribution and the estimated direction of movement distribution for the current position based at least partly on a previous position of the mobile device.

3. The method of claim 2, wherein said obtaining further comprises:
obtaining the estimated velocity distribution and the estimated direction of movement distribution for the current position based at least partly on a shortest map path between the previous position and the current position as constrained by the routability information.

4. The method of claim 3, wherein the routability information comprises a routing graph that corresponds to the at least a portion of the interior of the building structure and that indicates traversable paths and feasible locations.

5. The method of claim 3, wherein said obtaining further comprises:
estimating the estimated velocity distribution for the current position based at least partly on a length of the shortest map path.

6. The method of claim 3, wherein said obtaining further comprises:
estimating the estimated direction of movement distribution for the current position based at least partly on a segment of the shortest map path leading to the current position.

7. The method of claim 1, wherein said obtaining comprises:
determining a shortest map path between a previous position of the mobile device and the current position as constrained by the routability information;
estimating the estimated velocity distribution for the current position based at least partly on a length of the shortest map path; and
estimating the estimated direction of movement distribution for the current position based at least partly on a segment of the shortest map path leading to the current position.

8. The method of claim 1, wherein said estimating further comprises:
estimating the subsequent position of the mobile device based at least partly on a shortest map path between the current position and the subsequent position that begins in accordance with the estimated direction of movement distribution for the current position.

9. The method of claim 1, wherein said estimating comprises:
applying at least one weighting function along multiple directions of potential continued movement in accordance with the estimated direction of movement distribution for the current position; and
estimating the subsequent position of the mobile device based at least partly on the multiple directions of potential continued movement as weighted by the at least one weighting function and the estimated velocity distribution for the current position.

10. The method of claim 9, wherein said applying further comprises:
applying a probabilistic weighting function to probabilistically distribute the multiple directions of potential continued movement with respect to the estimated direction of movement distribution for the current position.

11. The method of claim 1, wherein said estimating further comprises:
estimating a subsequent position distribution of the mobile device based at least in part on the estimated velocity distribution and the estimated direction of movement distribution for the current position.

12. The method of claim 11, wherein each of the subsequent position distribution, the estimated velocity distribution for the current position, and the estimated direction of movement distribution for the current position comprises a probability distribution.

13. The method of claim 1, wherein said estimating comprises:
recursively determining a probability distribution of the subsequent position of the mobile device based at least partly on a joint probability distribution of the current position of the mobile device, an estimated direction of movement for the current position, and an estimated velocity for the current position; and
estimating the subsequent position of the mobile device based at least partly on the probability distribution of the subsequent position of the mobile device.

14. The method of claim 13, further comprising:
determining the joint probability distribution of the current position by applying a probabilistic weighting function to probabilistically distribute multiple directions of potential continued movement with respect to the estimated direction of movement for the current position.

15. A device comprising:
at least one memory to store instructions; and
one or more processors to execute said instructions and cause the device to:
obtain an estimated velocity distribution and an estimated direction of movement distribution for a current position of a mobile device based at least in part on routability information for a constrained environment that includes at least a portion of an interior of a building structure; and
estimate a subsequent position of the mobile device based at least in part on the estimated velocity distribution and the estimated direction of movement distribution for the current position.

16. The device of claim 15, wherein to obtain the estimated velocity distribution and the estimated direction of movement distribution said one or more processors are further to execute said instructions to:
obtain the estimated velocity distribution and the estimated direction of movement distribution for the current position based at least partly on a previous position of the mobile device.

17. The device of claim 16, wherein to obtain the estimated velocity distribution and the estimated direction of movement distribution said one or more processors are further to execute said instructions to:
obtain the estimated velocity distribution and the estimated direction of movement distribution for the current position based at least partly on a shortest map path between the previous position and the current position as constrained by the routability information.

18. The device of claim 17, wherein the routability information comprises a routing graph that corresponds to the at least a portion of the interior of the building structure and that indicates traversable paths and feasible locations.

19. The device of claim 17, wherein to obtain the estimated velocity distribution and the estimated direction of movement distribution said one or more processors are further to execute said instructions to:
estimate the estimated velocity distribution for the current position based at least partly on a length of the shortest map path.

20. The device of claim 17, wherein to obtain the estimated velocity distribution and the estimated direction of movement distribution said one or more processors are further to execute said instructions to:
estimate the estimated direction of movement distribution for the current position based at least partly on a segment of the shortest map path leading to the current position.

21. The device of claim 15, wherein to obtain the estimated velocity distribution and the estimated direction of movement distribution said one or more processors are further to execute said instructions to:
determine a shortest map path between a previous position of the mobile device and the current position as constrained by the routability information;
estimate the estimated velocity distribution for the current position based at least partly on a length of the shortest map path; and
estimate the estimated direction of movement distribution for the current position based at least partly on a segment of the shortest map path leading to the current position.

22. The device of claim 15, wherein to estimate the subsequent position said one or more processors are further to execute said instructions to:
estimate the subsequent position of the mobile device based at least partly on a shortest map path between the current position and the subsequent position that begins in accordance with the estimated direction of movement distribution for the current position.

23. The device of claim 15, wherein to estimate the subsequent position said one or more processors are further to execute said instructions to:
apply at least one weighting function along multiple directions of potential continued movement in accordance with the estimated direction of movement distribution for the current position; and
estimate the subsequent position of the mobile device based at least partly on the multiple directions of potential continued movement as weighted by the at least one weighting function and the estimated velocity distribution for the current position.

24. The device of claim 23, wherein to apply at least one weighting function along the multiple directions of potential continued movement said one or more processors are further to execute said instructions to:
apply a probabilistic weighting function to probabilistically distribute the multiple directions of potential continued movement with respect to the estimated direction of movement distribution for the current position.

25. The device of claim 15, wherein to estimate the subsequent position said one or more processors are further to execute said instructions to:
estimate a subsequent position distribution of the mobile device based at least in part on the estimated velocity distribution and the estimated direction of movement distribution for the current position.

26. The device of claim 25, wherein each of the subsequent position distribution, the estimated velocity distribution for the current position, and the estimated direction of movement distribution for the current position comprises a probability distribution.

27. The device of claim 15, wherein to estimate the subsequent position said one or more processors are further to execute said instructions to:
recursively determine a probability distribution of the subsequent position of the mobile device based at least partly on a joint probability distribution of the current position of the mobile device, an estimated direction of movement for the current position, and an estimated velocity for the current position; and
estimate the subsequent position of the mobile device based at least partly on the probability distribution of the subsequent position of the mobile device.

28. The device of claim 27, wherein said one or more processors are further to execute said instructions and cause the device to:
determine the joint probability distribution of the current position by applying a probabilistic weighting function to probabilistically distribute multiple directions of potential continued movement with respect to the estimated direction of movement for the current position.

29. An article comprising: at least one storage medium having stored thereon instructions executable by one or more processors to:
obtain an estimated velocity distribution and an estimated direction of movement distribution for a current position of a mobile device based at least in part on routability information for a constrained environment that includes at least a portion of an interior of a building structure; and
estimate a subsequent position of the mobile device based at least in part on the estimated velocity distribution and the estimated direction of movement distribution for the current position.

30. The article of claim 29, wherein to obtain the estimated velocity distribution and the estimated direction of movement distribution the instructions stored on said at least one storage medium are further executable by the one or more processors to:
obtain the estimated velocity distribution and the estimated direction of movement distribution for the current position based at least partly on a previous position of the mobile device.

31. The article of claim 30, wherein to obtain the estimated velocity distribution and the estimated direction of movement distribution the instructions stored on said at least one storage medium are further executable by the one or more processors to:
obtain the estimated velocity distribution and the estimated direction of movement distribution for the current position based at least partly on a shortest map path between the previous position and the current position as constrained by the routability information.

32. The article of claim 31, wherein the routability information comprises a routing graph that corresponds to the at least a portion of the interior of the building structure and that indicates traversable paths and feasible locations.

33. The article of claim 31, wherein to obtain the estimated velocity distribution and the estimated direction of movement distribution the instructions stored on said at least one storage medium are further executable by the one or more processors to:
estimate the estimated velocity distribution for the current position based at least partly on a length of the shortest map path.

34. The article of claim 31, wherein to obtain the estimated velocity distribution and the estimated direction of movement distribution the instructions stored on said at least one storage medium are further executable by the one or more processors to:
estimate the estimated direction of movement distribution for the current position based at least partly on a segment of the shortest map path leading to the current position.

35. The article of claim 29, wherein to obtain the estimated velocity distribution and the estimated direction of movement distribution the instructions stored on said at least one storage medium are further executable by the one or more processors to:
determine a shortest map path between a previous position of the mobile device and the current position as constrained by the routability information;
estimate the estimated velocity distribution for the current position based at least partly on a length of the shortest map path; and
estimate the estimated direction of movement distribution for the current position based at least partly on a segment of the shortest map path leading to the current position.

36. The article of claim 29, wherein to estimate the subsequent position the instructions stored on said at least one storage medium are further executable by the one or more processors to:
estimate the subsequent position of the mobile device based at least partly on a shortest map path between the current position and the subsequent position that begins in accordance with the estimated direction of movement distribution for the current position.

37. The article of claim 29, wherein to estimate the subsequent position the instructions stored on said at least one storage medium are further executable by the one or more processors to:
apply at least one weighting function along multiple directions of potential continued movement in accordance with the estimated direction of movement distribution for the current position; and
estimate the subsequent position of the mobile device based at least partly on the multiple directions of potential continued movement as weighted by the at least one weighting function and the estimated velocity distribution for the current position.

38. The article of claim 37, wherein to apply at least one weighting function along the multiple directions of potential continued movement the instructions stored on said at least one storage medium are further executable by the one or more processors to:
apply a probabilistic weighting function to probabilistically distribute the multiple directions of potential continued movement with respect to the estimated direction of movement distribution for the current position.

39. The article of claim 29, wherein to estimate the subsequent position the instructions stored on said at least one storage medium are further executable by the one or more processors to:
estimate a subsequent position distribution of the mobile device based at least in part on the estimated velocity distribution and the estimated direction of movement distribution for the current position.

40. The article of claim 39, wherein each of the subsequent position distribution, the estimated velocity distribution for the current position, and the estimated direction of movement distribution for the current position comprises a probability distribution.

41. The article of claim 29, wherein to estimate the subsequent position the instructions stored on said at least one storage medium are further executable by the one or more processors to:
recursively determine a probability distribution of the subsequent position of the mobile device based at least partly on a joint probability distribution of the current position of the mobile device, an estimated direction of movement for the current position, and an estimated velocity for the current position; and
estimate the subsequent position of the mobile device based at least partly on the probability distribution of the subsequent position of the mobile device.

42. The article of claim 41, wherein the instructions stored on said at least one storage medium are further executable by the one or more processors to:
determine the joint probability distribution of the current position by applying a probabilistic weighting function to probabilistically distribute multiple directions of potential continued movement with respect to the estimated direction of movement for the current position.

43. An apparatus comprising:
means for obtaining an estimated velocity distribution and an estimated direction of movement distribution for a current position of a mobile device based at least in part on routability information for a constrained-environment that includes at least a portion of an interior of a building structure; and
means for estimating a subsequent position of the mobile device based at least in part on the estimated velocity distribution and the estimated direction of movement distribution for the current position.

44. The apparatus of claim 43, wherein said means for obtaining the estimated velocity distribution and the estimated direction of movement distribution comprises:
means for obtaining the estimated velocity distribution and the estimated direction of movement distribution for the current position based at least partly on a previous position of the mobile device.

45. The apparatus of claim 44, wherein said means for obtaining the estimated velocity distribution and the estimated direction of movement distribution further comprises:
means for obtaining the estimated velocity distribution and the estimated direction of movement distribution for the current position based at least partly on a shortest map path between the previous position and the current position as constrained by the routability information.

46. The apparatus of claim 45, wherein the routability information comprises a routing graph that corresponds to the at least a portion of the interior of the building structure and that indicates traversable paths and feasible locations.

47. The apparatus of claim 45, wherein said means for obtaining the estimated velocity distribution and the estimated direction of movement distribution further comprises:
means for estimating the estimated velocity distribution for the current position based at least partly on a length of the shortest map path.

48. The apparatus of claim 45, wherein said means for obtaining the estimated velocity distribution and the estimated direction of movement distribution further comprises:
means for estimating the estimated direction of movement distribution for the current position based at least partly on a segment of the shortest map path leading to the current position.

49. The apparatus of claim 43, wherein said means for obtaining comprises:
means for determining a shortest map path between a previous position of the mobile device and the current position as constrained by the routability information;
means for estimating the estimated velocity distribution for the current position based at least partly on a length of the shortest map path; and
means for estimating the estimated direction of movement distribution for the current position based at least partly on a segment of the shortest map path leading to the current position.

50. The apparatus of claim 43, wherein said means for estimating the subsequent position comprises:
means for estimating the subsequent position of the mobile device based at least partly on a shortest map path between the current position and the subsequent position that begins in accordance with the estimated direction of movement distribution for the current position.

51. The apparatus of claim 43, wherein said means for estimating comprises:
means for applying at least one weighting function along multiple directions of potential continued movement in accordance with the estimated direction of movement distribution for the current position; and
means for estimating the subsequent position of the mobile device based at least partly on the multiple directions of potential continued movement as weighted by the at least one weighting function and the estimated velocity distribution for the current position.

52. The apparatus of claim 51, wherein said means for applying further comprises:
means for applying a probabilistic weighting function to probabilistically distribute the multiple directions of potential continued movement with respect to the estimated direction of movement distribution for the current position.

53. The apparatus of claim 43, wherein said means for estimating the subsequent position comprises:
means for estimating a subsequent position distribution of the mobile device based at least in part on the estimated velocity distribution and the estimated direction of movement distribution for the current position.

54. The apparatus of claim 53, wherein each of the subsequent position distribution, the estimated velocity distribution for the current position, and the estimated direction of movement distribution for the current position comprises a probability distribution.

55. The apparatus of claim 43, wherein said means for estimating comprises:
means for recursively determining a probability distribution of the subsequent position of the mobile device based at least partly on a joint probability distribution of the current position of the mobile device, an estimated direction of movement for the current position, and an estimated velocity for the current position; and
means for estimating the subsequent position of the mobile device based at least partly on the probability distribution of the subsequent position of the mobile device.

56. The apparatus of claim 55, further comprising:
means for determining the joint probability distribution of the current position by applying a probabilistic weighting function to probabilistically distribute multiple directions of potential continued movement with respect to the estimated direction of movement for the current position.
